(19) United States
(12) Patent Application Publication
(10) Pub. No.: US 2013/0298644 A1
(43) Pub. Date: Nov. 14, 2013

(54) Apparatus and Method For Measuring Viscosity of a Fluid

(71) Applicants: Robert Matthew Dean, Houston, TX (US); Jack Berroteran, San Ramon, CA (US); Sophany Thach, Houston, TX (US); Varadarajan Dwarakanath, Houston, TX (US); Will S. Slaughter, Houston, TX (US); Taimur Malik, Houston, TX (US)

(72) Inventors: Robert Matthew Dean, Houston, TX (US); Jack Berroteran, San Ramon, CA (US); Sophany Thach, Houston, TX (US); Varadarajan Dwarakanath, Houston, TX (US); Will S. Slaughter, Houston, TX (US); Taimur Malik, Houston, TX (US)

(73) Assignee: Chevron U.S.A. Inc., San Ramon, CA (US)

(21) Appl. No.: 13/892,952

(22) Filed: May 13, 2013

Related U.S. Application Data
(60) Provisional application No. 61/646,415, filed on May 14, 2012.

(51) Int. Cl. G01N 11/04

(52) U.S. Cl. CPC G01N 11/04
USPC 73/54.01

(57) ABSTRACT

An apparatus and method are provided for measuring the viscosity of a fluid. The apparatus typically includes an inlet line that is configured to receive a flow of the fluid, and at least one porous medium column that receives the flow of the fluid from the inlet line and resists the flow so that a pressure of the fluid at the outlet is less than a pressure of the fluid at the inlet. A pressure sensor is configured to measure a pressure differential between an inlet and outlet of the column, and the sensor is adapted to determine the viscosity of the fluid according to the pressure differential and the permeability of the porous medium.

### FIELD OF THE INVENTION

The present invention is generally related to the measurement of viscosity of a fluid, such as the measurement of fluid used in an enhanced oil recovery operation.

### BACKGROUND OF THE INVENTION

One conventional method of enhanced oil recovery (EOR) includes the injection of polymer into an oil reservoir. A reservoir can be flooded with polymer to control (e.g., decrease) the mobility of water that is injected into the reservoir, reduce the permeability of the reservoir, and/or to increase sweep efficiency. Polymer can be used either alone or in combination with a surfactant. A polymer flood can increase the rate and/or total volume of produced oil and can be used as an alternative to thermal EOR methods, for example, in the production of heavy or viscous oil.

In a typical polymer flood, polymer from a source is mixed on-site and then injected into the reservoir through the well head equipment of one or more wells. The mixing process can vary depending on the initial state of the polymer as it is supplied. For example, the polymer can be provided as a powder that is mixed with water on-site, or the polymer can be provided in a partial-strength solution, such as gel, emulsion, or other fluid that is made up partly of polymer (e.g., 2%-60% polymer) in a solute such as water.

Understanding and controlling the characteristics of the injected polymer mixture can be significant to the success of the polymer flood. One such characteristic is the viscosity of the polymer mixture, which can be measured before it is injected into the reservoir. A conventional method for measuring viscosity is to use an in-line viscometer that operates in real-time. Typical viscometers operate most accurately at specific shear rates or ranges, which are typically relatively high. However, since EOR often involves the injection of non-Newtonian fluids, such as shear-thinning, or pseudoplastic, fluids, i.e., characterized by a viscosity that decreases with increasing rate of shear stress, the conventional devices may not provide accurate results, particularly if oxygen and/or iron are present, as those materials can also affect the viscosity. Accordingly, where accurate viscosity measurements of a polymer mixture for EOR are desired, a common conventional method is to remove a sample of the fluid that is being injected and deliver the sample to a laboratory where the sample can be analyzed in a controlled environment. While laboratory analysis can be successful, the delay associated with sending samples to a laboratory is often undesirable.

Thus, there exists a need for a method of measuring viscosity, particularly the viscosity of non-Newtonian fluids such as the shear-thinning, or pseudoplastic, fluids, e.g., where viscosity decreases with increasing rate of shear stress, that are commonly injected during EOR.

### SUMMARY OF THE INVENTION

The present invention provides an apparatus and method for measuring the viscosity of a fluid. According to one embodiment, the apparatus includes an inlet line that is configured to receive a flow of the fluid, and at least one porous medium column defining an inlet and an outlet and configured to (a) direct the flow of the fluid from the inlet to the outlet so that the fluid flows through a porous medium of predetermined permeability in the porous medium column and (b) resist the flow of the fluid so that a pressure of the fluid at the outlet is less than a pressure of the fluid at the inlet. A pressure sensor is configured to measure a pressure differential between the pressure of the fluid at the inlet and the pressure of the fluid at the outlet, and the pressure sensor is adapted to determine and/or indicate the viscosity of the fluid according to the pressure differential and the permeability of the porous medium. A bypass line with a bypass valve can be provided for selectively communicating across the pressure sensor. One or more valves can be provided throughout the system and configured to restrict the flow of the fluid through the column and thereby regulate the flow to a desired flow rate.

In some cases, the apparatus can include a plurality of the porous medium columns, which can be arranged in parallel so that the flow of the fluid can be selectively directed through any one or more of the porous medium columns at a particular time. A similar porous medium can be provided in all of the columns, e.g., so that the different columns can be used at different times for similar viscosity measurements. Alternatively, each porous medium column contains a porous medium, and the porous media of the different porous medium columns can be different so that the fluid can be selectively directed through different porous media in the different columns.

The apparatus can include a sample vessel for receiving the fluid. The apparatus can be configured to redirect the flow of fluid entering the inlet line from the porous medium column to the sample vessel and thereby deposit a sample of the fluid in the vessel. The sample vessel can be removable from the apparatus so that the sample can be removed and transported to another location, e.g., for other analysis.

The apparatus can also include a fluid source that is configured to provide an enhanced oil recovery (EOR) liquid with non-Newtonian viscosity to the inlet as the fluid. The apparatus can be configured to determine the viscosity of the EOR liquid as the EOR liquid is injected through a well to a hydrocarbon reservoir.

According to another embodiment, the present invention provides a method for measuring viscosity of a fluid. The method includes receiving a flow of the fluid and directing the flow of the fluid through at least one porous medium column defining an inlet and an outlet so that a porous medium of predetermined permeability in the porous medium column resists the flow of the fluid and a pressure of the fluid at the outlet is less than a pressure of the fluid at the inlet. A pressure differential is measured between the pressure of the fluid at the inlet and the pressure of the fluid at the outlet. One or more valves can be adjusted to thereby restrict the flow of the fluid and regulate the flow through the porous medium column to a desired flow rate. The viscosity of the fluid is determined according to the pressure differential and the permeability of the porous medium. A bypass valve can be adjusted to adjust a fluid connection between an inlet and outlet of the pressure sensor.

In some cases, the fluid can be selectively directed through at least two of a plurality of porous medium columns. The fluid can be selectively directed through different porous media that each have the same permeability or that each have a different permeability.

The flow of fluid can also be redirected from the porous medium column to a sample vessel via a sample line. A sample of the fluid can be deposited in the vessel via the sample line, and the vessel with the sample can be removed from the sample line.

For example, the fluid can be delivered as an enhanced oil recovery (EOR) liquid with non-Newtonian viscosity, and the viscosity of the EOR liquid can be determined as the EOR liquid is injected through a well to a hydrocarbon reservoir.

### BRIEF DESCRIPTION OF THE DRAWINGS

FIG. 1 is a schematic view illustrating an apparatus for measuring the viscosity of a fluid, such as an enhanced oil recovery material that is injected through a well to a hydrocarbon reservoir, according to one embodiment of the present invention; and

FIG. 2 is a schematic view illustrating an apparatus according to another embodiment of the present invention, the apparatus including a plurality of porous medium columns through which the fluid can be directed.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

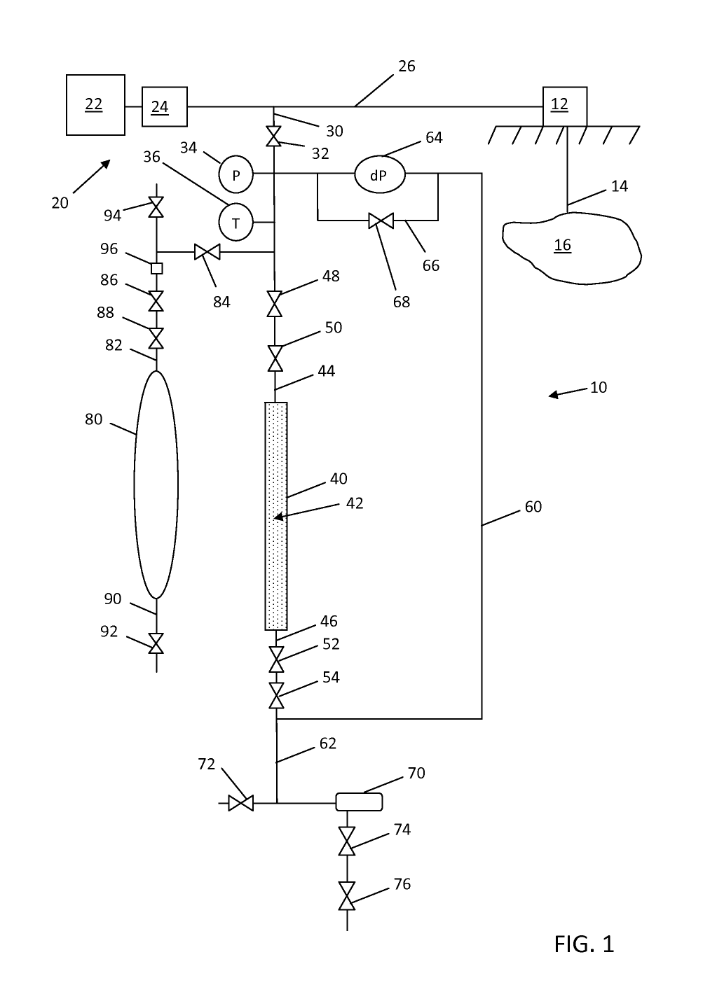

Referring to FIG. 1, there is shown an apparatus 10 for measuring the viscosity of a fluid, such as a polymer-containing fluid that is injected via a well head or other well equipment 12 and through a well 14 into a hydrocarbon reservoir 16 during a polymer injection operation for enhanced oil recovery (EOR). The apparatus 10 can be used to measure viscosity of a variety of such fluids, including fluids that exhibit non-Newtonian characteristics, such as the shear-thinning or pseudoplastic nature of fluids that have decreasing viscosity with increasing rates of shear stress.

In the embodiment of FIG. 1, the apparatus 10 is configured to receive fluid from a fluid source 20. The fluid source 20 can include one or more vessels 22 that store and supply the fluid. In some cases, the fluid can be mixed on-site, e.g., by mixing a polymer in the form of a powder, gel, emulsion, or liquid, with a solute such as water. The mixing of the polymer and solute can be performed in a mixing device 24, which can also include a pump for injecting the fluid through a pipe or other tubular passage 26 in fluid communication with the well 14.

In particular, the apparatus 10 can define an inlet line 30 that is configured to receive a flow of the fluid from the line 26, e.g., by a T-connection that allows the flow of fluid from the source 20 to be split so that, while the fluid is injected through the well 14, a portion of the fluid flows through the inlet line 30. The flow of fluid through the inlet line 30 and, hence, through the apparatus 10, can be controlled by a ball valve 32 disposed along the inlet line 30.

Sensors are configured to detect the characteristics of the fluid entering the apparatus 10. For example, a pressure sensor 34 can detect the absolute or gauge pressure of the fluid, and a temperature sensor 36 can detect the temperature of the fluid. Other sensors can also be provided for detecting other characteristics of the fluid or its flow.

The apparatus 10 includes at least one porous medium column 40 through which the fluid can be directed. The porous medium column 40 can include a vessel- or passage-like structure that defines an interior volume, in which a porous medium 42 is disposed. As illustrated, the porous medium column 40 defines an inlet 44 and an outlet 46 and is configured to direct the flow of the fluid from the inlet 44 to the outlet 46 so that the fluid flows through the porous medium 42 in the column 40. The porous medium 42 is typically a packed, granular material, which has a predetermined permeability. As the fluid flows through the porous medium column 40, the porous medium 42 resists the flow of the fluid so that a pressure drop occurs across the column 40. That is, the pressure of the fluid at the outlet 46 is less than the pressure of the fluid at the inlet 44.

Ball valves 48, 50, 52, 54 can be disposed upstream and downstream of the porous medium column 40 so that the flow of the fluid therethrough can be controlled. In some cases, the various valves of the apparatus 10 can be adjusted to achieve a desired flux or flow rate (on a mass or volumetric basis). The ball valves 48, 50, 52, 54 can also be used to terminate the flow through the column 40, e.g., if the column 40 is to be removed from the apparatus 10 for maintenance or replacement.

A pressure line 60 is configured to communicate between points upstream and downstream of the porous medium column 40. In particular, a first end of the pressure line 60 can connect to the inlet line 30, and the opposite end of the pressure line 60 can connect to the line 62 extending from the outlet 46 of the porous medium column 40. A differential pressure sensor 64 is disposed along the pressure line 60 and configured to determine the pressure drop through the porous medium column 40 by measuring the difference between the pressures at the inlet 44 and outlet 46 of the porous medium column 40. A bypass line 66 and bypass valve 68 can be provided for fluidly connecting points upstream and downstream of the differential pressure sensor 64 and thereby bypassing the differential pressure sensor 64.

The viscosity of the fluid can be determined according to the pressure differential and the permeability of the porous medium 42. In particular, while the present invention is not bound by any particular theory of operation, it is appreciated that the pressure differential and permeability are related by Darcy's law:

q=(−k/μ)∇P (Equation 1)

where
q is the flux (discharge of the fluid per unit of cross-sectional flow area in the column 40);
k is the permeability of the porous medium 42;
μ is the viscosity of the fluid; and
∇P is the pressure differential measured by the differential pressure sensor 64.

The pressure sensor 64 can be calibrated so that it graphically indicates a value that is equal to or indicative of the viscosity. In some cases, the pressure sensor 64 can communicate with another output device to output values in other manners. For example, the pressure sensor 64 can determine a value indicative of the viscosity and communicate that value electronically to an electronic display that graphically illustrates the viscosity, and/or to a computer or other processing device that can record, store, and/or process the values over a period of time during which the apparatus 10 operates.

Pressure relief devices can be provided throughout the apparatus 10 to prevent pressure from exceeding predetermined values. For example, as shown in FIG. 1, the fluid exiting the porous medium column 40 can be directed through a pressure relief device 70, which can be configured to automatically vent the fluid from the apparatus 10 if a predetermined pressure is exceeded within the apparatus 10. Regulating shut-off valves 72, 74 can also be provided for the purpose of releasing pressure and purging the lines 72 and regulating discharge pressures 74. The flow of fluid can also be directed through a metering valve 76, which can be configured to operate either manually or automatically to maintain a desired flow rate through the apparatus 10.

The apparatus 10 can also provide a mechanism for sampling the fluid. In this regard, FIG. 1 illustrates a sample vessel 80, which can be a cylinder of sufficient volume to receive and store a sample of the fluid. The sample vessel 80 has an inlet 82 connected to the inlet line 30 via one or more ball valves 84, 86, 88 that can be opened to allow the fluid to flow into the vessel 80 and then closed to stop the flow into the vessel 80 when a sufficient sample has been received. A sample vessel outlet 90 with a ball valve 92 can also be provided to allow fluid to be vented from the vessel 80. A regulating shut-off valve 94 can be configured to vent fluid upstream of the vessel 80.

By opening valves 84, 86, 88 (and, typically, closing one or more of the valves 48, 50, 52, 54, 74, 76 to stop the flow through the column 42), fluid flowing toward the porous medium column 40 can be redirected and, instead of flowing into the column 40, can flow from the inlet line 30 to the sample vessel 80 and deposited in the vessel 80. The vessel 80 can be connected to the line 30 by a removable connection 96 so that the vessel 80 can easily be removed from the apparatus 10. For example, the connection 96 can be a quick-connect device that allows the sample vessel 80 to be readily removed and reattached without tools. Once removed, the vessel 80 can be stored, transported to a remote location for analysis, or otherwise processed.

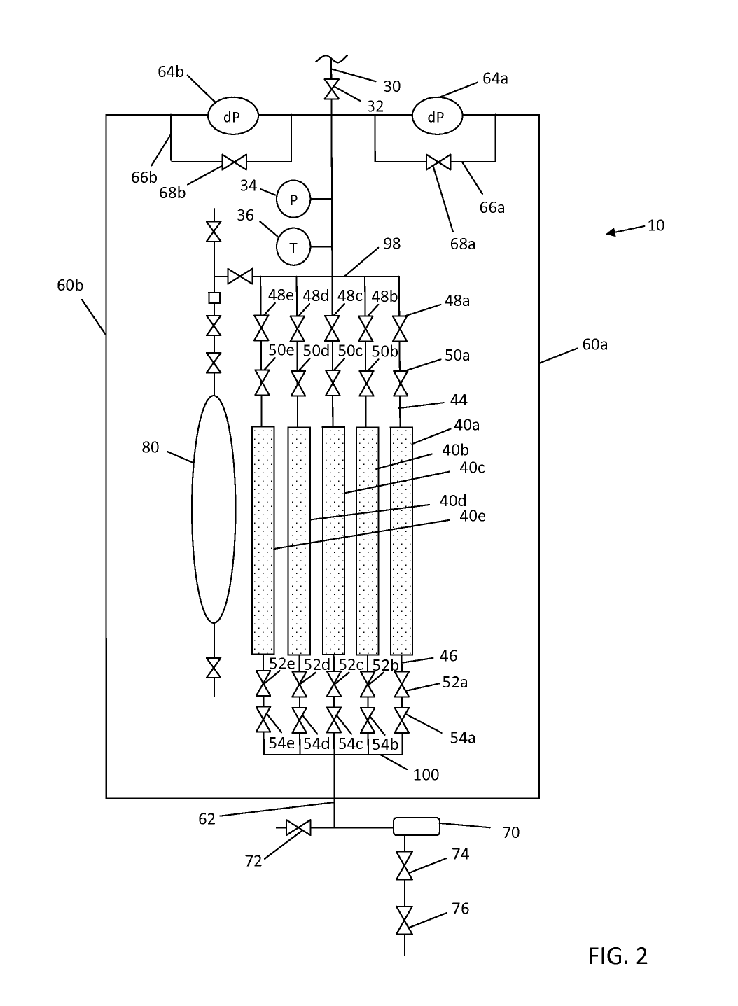

FIG. 2 illustrates another embodiment of the present invention, in which the apparatus 10 includes a plurality of porous medium columns 40a, 40b, 40c, 40d, 40e (referred to collectively by reference numeral 40). The columns 40 are arranged in a parallel arrangement, with the inlet 44 of each column 40 connected to the inlet line 30 via an inlet manifold 98 and the outlet 46 of each column 40 connected by an outlet manifold 100. Valves 48a-48e, 50a-50e, 52a-52e, 54a-54e, are provided between the columns 40 and the manifolds 98, 100, both upstream and downstream of the columns 40, so that the flow of the fluid can be selectively directed through each of the porous medium columns 40.

Each column 40 can contain a porous medium 42. The porous medium 42 in each column 40 and the predetermined permeability of the column 40 can be the same as or different than the other columns 40. For example, in one embodiment, the columns 40 can contain the same porous medium 42 with substantially the same permeability so that any of the columns 40 can be used for a similar viscosity determination. It may be desirable to direct fluid first through only the first column 40a for viscosity measurements and, thereafter, to cease the flow of fluid through the first column 40a and instead direct the flow through the second column 40b. Redirecting the flow sequentially among the columns 40 may be desirable, e.g., if one of the columns 40 becomes clogged, malfunctions or breaks, or otherwise needs repair or replacement.

Alternatively, the columns 40 can be provided with different permeabilities by using different porous media 42 or by configuring the porous media 42 or the columns 40 differently. In this case, one of the columns 40 can be chosen for a viscosity measurement operation according to the characteristics of the fluid or its flow. For example, it might be desired to use a column 40 with a higher permeability if the viscosity of the fluid is relatively high, and it might be desired to use a column 40 with a lower permeability if the viscosity of the fluid is relatively low.

When a particular column 40 is not being used, the respective valves 48a-48e, 50a-50e upstream and the respective valves 52a-52e, 54a-54e downstream of the column 40 can be closed, and the column 40 can be removed if maintenance is required. For example, a column 40 that is used for viscosity measurements might become clogged if a powder polymer is not adequately mixed and a quantity of dry powder is carried with the fluid into the column 40 and deposited in the porous medium 42. A clogged column 40 can be removed so that the porous medium 42 can be replaced, and the column 40 can then be reinstalled in the apparatus 10 for additional service. While a column 40 is removed, the apparatus 10 can continue to operate by directing the flow of fluid through a different column 40.

First and second differential pressure sensors 64a, 64b can be provided for redundancy, along with first and second pressure lines 60a, 60b, first and second bypass lines 66a, 66b, and first and second bypass valves 68a, 68b. The two differential pressure sensors 64a, 64b can be used simultaneously and compared, e.g., so that any reduction in accuracy of one of the sensors 64a, 64b can be determined promptly. Alternatively, the two sensors 64a, 64b can be used separately, e.g., alternately for successive operations, or each can be used only if the opposite sensor 64a, 64b is not operable due to repair or maintenance issues.

A variety of porous media 42 can be provided in the columns 40, typically depending on the type of fluid that will be measured. For example, the following materials can be used as porous media 42: Spherical balls in uniform or multiple diameters made of metals, ceramics, plastics or glass. Clastic or carbonate sand, unconsolidated reservoir or outcrop core sieved to a single or a range of mesh sizes and intact reservoir or outcrop core disaggregated and sieved to a single or a range of mesh sizes.

The various components of the apparatus 10 can be formed of different materials that are appropriate for handling the fluids that will be measured. For example, in some cases, the columns 40, lines 30, 60, 62, 66, valves 32, 48, 50, 52, 54, 68, 72, 74, 76, 84, 86, 88, 90, 92, 94, 96, vessel 80, and any connectors and fittings therebetween can be formed of steel, other metals, plastics, and the like. In some environments, it might be desirable to use stainless steel, other oxidation-resistant materials, or components with oxidation-resistant coatings.

While specific types of valves are described herein, the present invention is not limited to the use of these specific types of valves. In fact, other types of valves can be used throughout the apparatus 10, and the valves can be located and configured in alternative manners.

It is appreciated that the apparatus 10 can be used to measure the viscosity of a variety of fluids, which can be provided from different types of fluid sources 20. If the fluid is an enhanced oil recovery (EOR) liquid that is injected through a well 14 to an underground hydrocarbon reservoir 16, the apparatus 10 can be operated simultaneously with the injection operation so that the viscosity is measured as the fluid is injected into the reservoir 16. The viscosity can be measured at successive times during the operation, or even continuously during the operation of the well 14. Further, the apparatus 10 can be monitored by an operator, or the apparatus 10 can be configured to provide a visual, audible, or other alert to an operator, if the apparatus 10 detects conditions outside of a predetermined range. For example, the apparatus 10 can be configured to alert an operator if the viscosity is less than a low threshold value or higher than a high threshold value. If the viscosity measurement is outside a predetermined range, the injection operation may be interrupted, e.g., manually by the operator or automatically by an electrical signal issued by the apparatus 10 to the fluid source 20 or the well equipment 12.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed:

1. An apparatus for measuring viscosity of a fluid, the apparatus comprising:
an inlet line configured to receive a flow of the fluid;
at least one porous medium column defining an inlet and an outlet and configured to (a) direct the flow of the fluid from the inlet to the outlet such that the fluid flows through a porous medium of predetermined permeability in the porous medium column and (b) resist the flow of the fluid such that a pressure of the fluid at the outlet is less than a pressure of the fluid at the inlet; and
a pressure sensor configured to measure a pressure differential between the pressure of the fluid at the inlet and the pressure of the fluid at the outlet,
wherein the pressure sensor is adapted to determine the viscosity of the fluid according to the pressure differential and the permeability of the porous medium.

2. An apparatus according to claim 1 wherein the apparatus comprises a plurality of porous medium columns arranged in parallel such that the flow of the fluid can be selectively directed through each of the porous medium columns.

3. An apparatus according to claim 2 wherein each of the porous medium columns contains a porous medium, the porous media of the different porous medium columns being different such that the fluid can be selectively directed through different porous media in the different porous medium columns.

4. An apparatus according to claim 1 further comprising a sample vessel for receiving the fluid, wherein the apparatus is configured to redirect the flow of fluid entering the inlet line from the porous medium column to the sample vessel and thereby deposit a sample of the fluid in the vessel.

5. An apparatus according to claim 1 further comprising at least one valve configured to restrict the flow of the fluid and thereby regulate the flow to a desired flow rate.

6. An apparatus according to claim 1 further comprising a bypass line with a bypass valve for selectively communicating across the pressure sensor.

7. An apparatus according to claim 1 further comprising a fluid source configured to provide an enhanced oil recovery (EOR) liquid with non-Newtonian viscosity to the inlet as the fluid such that the apparatus is configured to determine the viscosity of the EOR liquid as the EOR liquid is injected through a well to a hydrocarbon reservoir.

8. A method for measuring viscosity of a fluid, the method comprising:
receiving a flow of the fluid;
directing the flow of the fluid through at least one porous medium column defining an inlet and an outlet such that a porous medium of predetermined permeability in the porous medium column resists the flow of the fluid and a pressure of the fluid at the outlet is less than a pressure of the fluid at the inlet;
measuring a pressure differential between the pressure of the fluid at the inlet and the pressure of the fluid at the outlet; and
determining the viscosity of the fluid according to the pressure differential and the permeability of the porous medium.

9. A method according to claim 8 wherein the directing step comprises selectively directing the fluid through at least two of a plurality of porous medium columns.

10. A method according to claim 9 wherein the directing step comprises selectively directing the fluid through different porous media, each having a different permeability.

11. A method according to claim 8 further comprising redirecting the flow of fluid from the porous medium column to a sample vessel via a sample line, depositing a sample of the fluid in the vessel via the sample line, and removing the vessel with the sample from the sample line.

12. A method according to claim 8 further comprising adjusting at least one valve to thereby restrict the flow of the fluid and regulate the flow through the porous medium column to a desired flow rate.

13. A method according to claim 8 further comprising adjusting a bypass valve to adjust a fluid connection between an inlet and outlet of the pressure sensor.

14. A method according to claim 8 further comprising delivering the fluid as an enhanced oil recovery (EOR) liquid with non-Newtonian viscosity and determining the viscosity of the EOR liquid as the EOR liquid is injected through a well to a hydrocarbon reservoir.
